(19) United States
(12) Patent Application Publication
(10) Pub. No.: US 2011/0311195 A1
(43) Pub. Date: Dec. 22, 2011

(54) METHOD AND APPARATUS FOR VIDEO RECORDING AND PLAYBACK

(75) Inventors: Yusuke IKEDA, Fukaya-shi (JP); Satoshi KATAOKA, Fukaya-shi (JP)

(73) Assignee: KABUSHIKI KAISHA TOSHIBA, Tokyo (JP)

(21) Appl. No.: 13/161,952

(22) Filed: Jun. 16, 2011

(30) Foreign Application Priority Data
Jun. 16, 2010 (JP) 2010-137674

(51) Int. Cl. H04N 5/775

(52) U.S. Cl. 386/230; 386/E05.002

(57) ABSTRACT

According to one embodiment, a video display device including, a signal playback module configured to receive content to be played back by a source device, a signal control module configured to instruct the source device to stop and start playback of the content, and a bidirectional communication interface configured to connect the signal control module and the signal playback module such that a control signal can be transferred to and from the source device.

### CROSS-REFERENCE TO RELATED APPLICATIONS

This application is based upon and claims the benefit of priority from Japanese Patent Application No. 2010-137674, filed Jun. 16, 2010; the entire contents of which are incorporated herein by reference

### FIELD

Embodiments described herein relate generally to a recording and playback device connected to a video display device via a bidirectional communication interface and a method for controlling a playback signal.

### BACKGROUND

A video display device connected to a record playback device via a bidirectional communication interface, such as a High-Definition Multimedia Interface (HDMI), is powered on upon receiving an instruction to start playback of a video from the record playback device and displays the video played back by the record playback device.

When an instruction to start playback of a video is given, the record playback device starts playback of the video until the video display device has become able to play back the video, regardless of the time necessary for input switching, for example. This becomes a cause for generating “head missing”, in which the video of a predetermined period of time is played back at the point in time when the video display device has displayed the video.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a configuration of an embodiment, according to an embodiment;

FIG. 2 is an exemplary diagram showing an example of an embodiment of the camera device according to an embodiment;

FIG. 3 is an exemplary diagram showing an example of signal transfer of an exemplary configuration according to an embodiment;

FIG. 4 is an exemplary diagram showing an example of signal transfer of an exemplary configuration according to an embodiment;

FIG. 5 is an exemplary diagram showing an example of signal transfer of an exemplary configuration according to an embodiment;

FIG. 6 is an exemplary diagram showing an example of a device to which an embodiment is applied, according to an embodiment; and

FIG. 7 is an exemplary diagram showing an example of a device to which an embodiment is applied, according to an embodiment.

### DETAILED DESCRIPTION

Various embodiments will be described hereinafter with reference to the accompanying drawings. In general, according to one embodiment, a video display device comprising: a signal playback module configured to receive content to be played back by a source device; a signal control module configured to instruct the source device to stop and start playback of the content; and a bidirectional communication interface configured to connect the signal control module and the signal playback module such that a control signal can be transferred to and from the source device.

Embodiments will now be described hereinafter in detail with reference to the accompanying drawings.

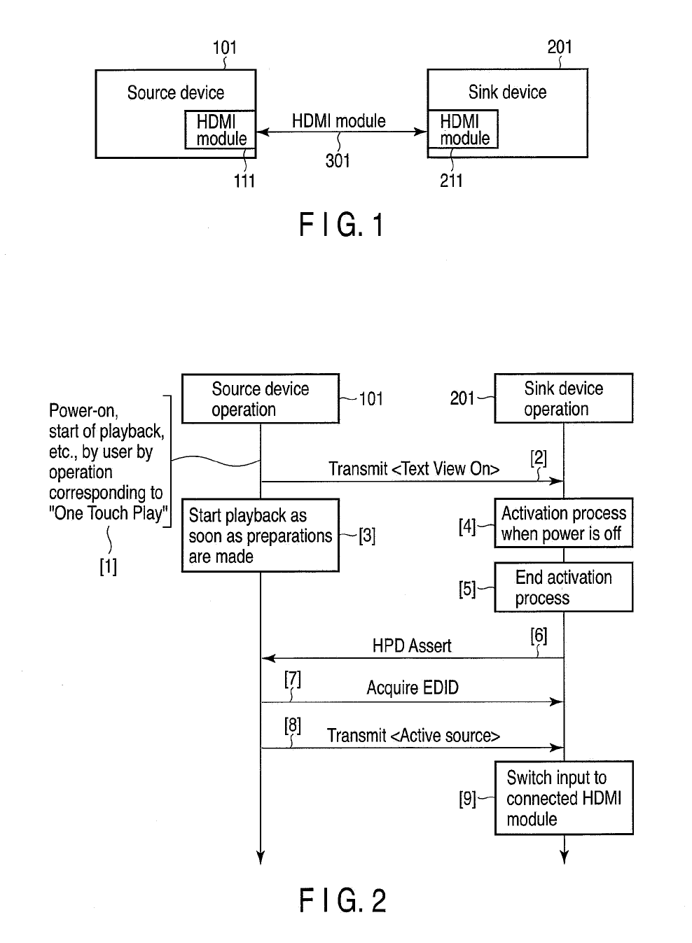

FIG. 1 shows an example of a record playback device to which the embodiment is applied and a video display device connected to the record playback device. The component referred to as “module” below may be realized by hardware or by software in a CPU (microcomputer), etc.

A record playback device (recorder) 101 is connected to a video display device (monitor device or a display) 201 to which a played-back video signal is supplied, via a bidirectional communication interface, such as a High-Definition Multimedia Interface (HDMI) module 301. The HDMI module 301 is compatible with the Consumer Electronics Control (CEC) <HDMI-CEC> standard, which was established later. The record playback device 101 shown in FIG. 1 includes a player device and a game device for playing back video and audio, a video camera, and the like. Of course, the record playback device 101 may be embodied as a disc drive device that can be connected to a personal computer (PC) or a disc drive device, or a navigation device that can be mounted on a vehicle, for example, or can be carried by a user. Further, the elements/configurations that will be described hereinafter may be embodied either as hardware or as software using a microcomputer (processor, CPU, etc.), for example.

The record playback device 101 will be referred to as a source device, and the video display device 201 will be referred to as a sink device of the source device. The record playback device (source device) 101 includes an HDMI interface module 111, and the video display device (sink device) 201 includes an HDMI interface module 211.

The HDMI (-CEC) 301 includes a CEC-line, mutually connects the HDMI interface portion 111 of the source device (recorder/record playback device) 101 and the HDMI interface module 211 of the sink device (monitor device or a display/video display device) 201, and provides an interlocking function therebetween.

The interlocking function using the CEC-line includes “One Touch Play” operation of activating the system of the sink device 201 and switching to an input to which the source device 101 is connected, “Remote Control Pass Through” of notifying the source device 101 of a control command output by the operation of a remote controller of the sink device 201, and the like. Operations corresponding to the “Remote Control Pass Through” include “Playback” and “Stop/Pause”, special playbacks such as “Fast-Forward/Fast-Rewind”, setting (loading) the optical disc, and the like.

Accordingly, even when the sink device 201 is powered off, when the source device 101 instructs playback of content (a video or audio signal) held by the source device 101 or sets an optical disc, the sink device 201 is powered on and a top menu contained in the content or the optical disc about which the instruction has been made or a playback video of a scene that is set to be played back first is displayed on the sink device 201.

FIG. 2 schematically shows an operation command sequence of the “One Touch Play”.

When the user has made an operation corresponding to the “One Touch Play” via the source device 101 [1], <Text View On> command is transmitted from the source device 101 to the sink device 201 [2], and playback of the content is started as soon as the content playback is ready [3].

Upon receipt of <Text View On>, the sink device 201 executes power-on and activation processes when the power is not on [4].

After activation of the sink device 201 has ended [5], the sink device 201 asserts Hot Plug Detected (HPD) into HI (<HPD assert>, L→H), and causes the source device 101 to read Extended Display Identification Data (EDID) [6].

In response to the HPD assertion, the source device 101 judges that the sink device 201 has been activated, acquires (reads) the EDID [7], and then transmits <Active Source> command to the sink device 201 [8].

Upon receipt of the <Active Source> command, the sink device 201 switches its input to an HDMI (HDMI module 211) connected thereto, performs recognition of High-bandwidth Digital Content Protection (digital rights management [DRM]), and displays the received video and outputs the audio [9].

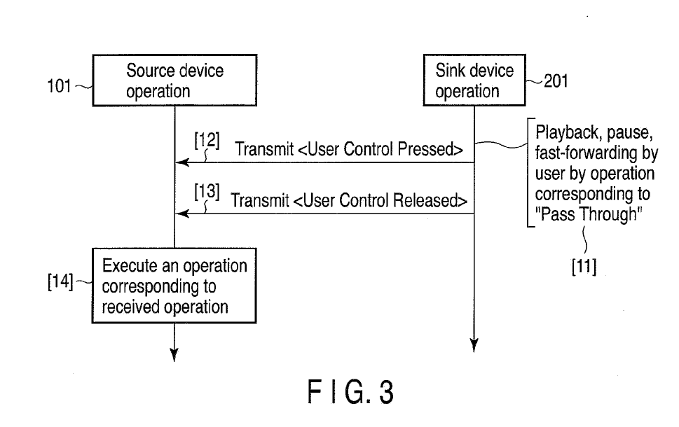

FIG. 3 schematically shows an operation command sequence of the “Remote Control Pass Through”.

When the user has made an operation corresponding to the “Remote Control Pass Through” to the sink device 201 as shown in FIG. 3 [11], the sink device 201 notifies the source device 101 of <User Control Pressed> (press of button/press of corresponding operation key) of the corresponding operation key [12] and of <User Control Released> (release of button/release of corresponding operation key) [13], that is, of a request (instruction) for “a pseudo-operation of a remote controller terminal”. It is to be noted that the period of time between the press of the button (User Control Pressed) [12] and the release of the button (User Control Pressed Released) [13] corresponds to the “pseudo-operation of a remote controller terminal”.

After receiving off [13] from the sink device 201, the source device 101 executes an operation according to the received operation [14].

Since the source device 101 starts playback of content based on the “One Touch Play” described with reference to FIG. 2 as soon as the playback is ready, there are not negligible cases where the content played back by the source device 101 is input while the sink device 201 is switching its input such that the video signal and the audio signal from the source device 101, a video is played back for a predetermined period of time at the point in time when the video display device has displayed the video, can be accepted. This is called “HEAD MISSING”, which should desirably be eliminated as much as possible. On the other hand, since playback preparation time is not needed in the case of resume playback from the state in which the source device 101 is already ready for playback, or in the case of playback of a music disc that does not have a menu screen, the content missing time will be longer. In such cases, the user causes great discomfort, and “playback from the head of the content” will be required through an operation of a remote controller terminal (remote controller) or an operation portion (no shown), for example.

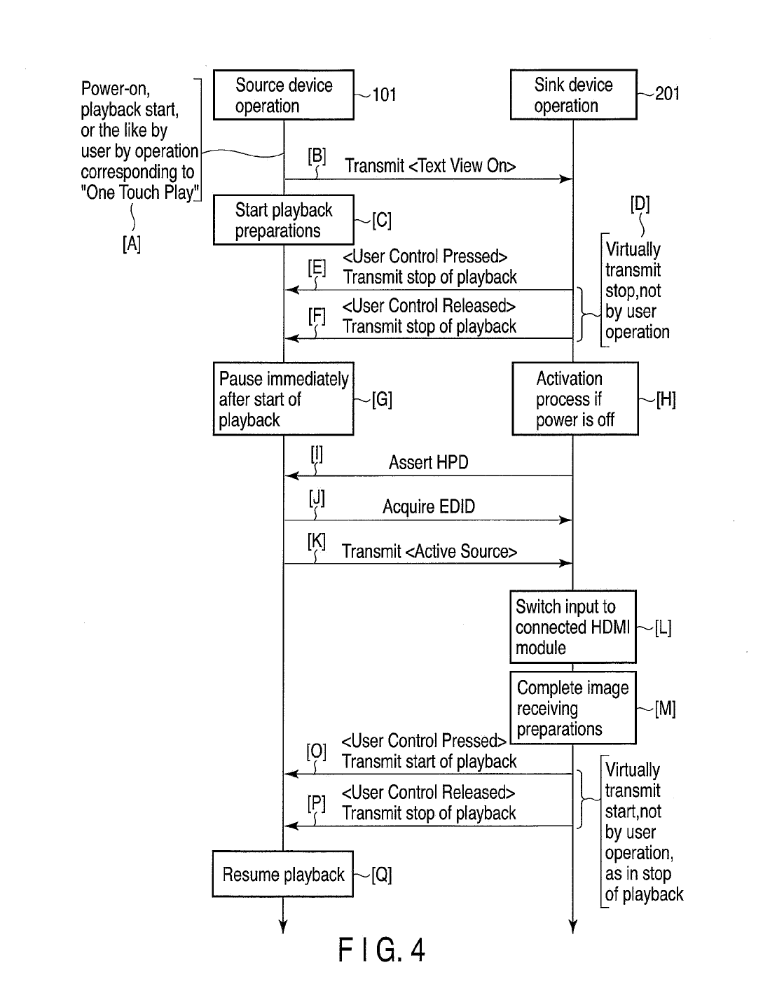

FIG. 4 illustrates an example of an embodiment.

When the user has made an operation corresponding to the “One Touch Play” [A], the source device 101 transmits a <Text View On> command to the sink device 201 [B]. The source device 201 starts playback of the content simultaneously [C].

Upon receipt of the <Text View On> command, the sink device 201 gives a playback stop instruction to the source device 101 with the “Remote Control Pass Through”, in order to cause the source device 101, which outputs video and audio signals, to stop playback of the content [D], and starts an activation process [H]. Although a detailed description will be omitted, when the sink device 201 is powered off (non-on state), the activation process [H] includes powering on the sink device 201, taking advantage that the secondary battery (direct-current (DC) 31V, 24V, 5V, or the like) to the control CPU portion, for example, excluding elements that require relatively large power consumption is usually secured in cases other than a case where energizing is physically difficult, such as the case where the plug is pulled off. Further, the “Remote Control Pass Through” [D] is the press of the button [E] or the release of the button [F] described in FIG. 3, that is, a request for “pseudo-operation of a remote controller terminal”.

The source device 101 receives a playback stop instruction with “Remote Control Pass Through” from the sink device 201, and waits in a pause state immediately after making playback preparations and starting playback [G].

The source device 101 maintains the pause state until it receives HPD assertion informing that the sink device 201 has been activated from the sink device 201. After receiving the assertion [I], the source device 101 acquires (reads) the EDID from the sink device 201 [J], and transmits <Active Source> to the sink device 201 [K].

Upon receipt of the <Active Source> command, the sink device 201 switches its input to the HDMI (HDMI module 211) connected thereto, performs HDCP (DRM) recognition, and displays the received video and outputs the audio [L].

After that, at the point in time when the sink device 201 is ready for receiving the video and the audio from the source device 101 [M], the sink device 201 notifies the source device 101 of the press of the button

and the release of button [P] indicating start of playback, that is, “release of the pseudo-operation of the remote controller terminal” [N].

Upon receipt of the “release of the pseudo-operation of the remote controller terminal” from the sink device 201, the source device 101 starts playback of the content that is maintained in the pause state [Q]. During the period of time until pause of the source device 101 is released and playback of the content is started ([Q]) after playback stop with the “Remote Control Pass Through” is received from the sink device 201, playback preparations are made, and playback is started (corresponding to [G]), a character string such as “Playback being prepared” is displayed on a display portion (including a display portion of a segment type or a matrix type such as a LCD panel capable of displaying character strings or a clock and capable of displaying the current time and character strings) of the source device 101. Alternatively, instead of “display of the character string”, a display indicating that playback is being prepared, such as a blinking display “PLAY” is displayed.

With the above-described configuration, when videos and audios acquired by playing back the content by applying the “One Touch Play” are transmitted to the sink device 201 from the source device 101 connected via the HDMI (-CEC) 301, the “HEAD MISSING”, which is caused by input of a video and an audio from the source device 101 during the period of time until the video and the audio from the source device 101 can be received by the sink device 201 can be substantially suppressed.

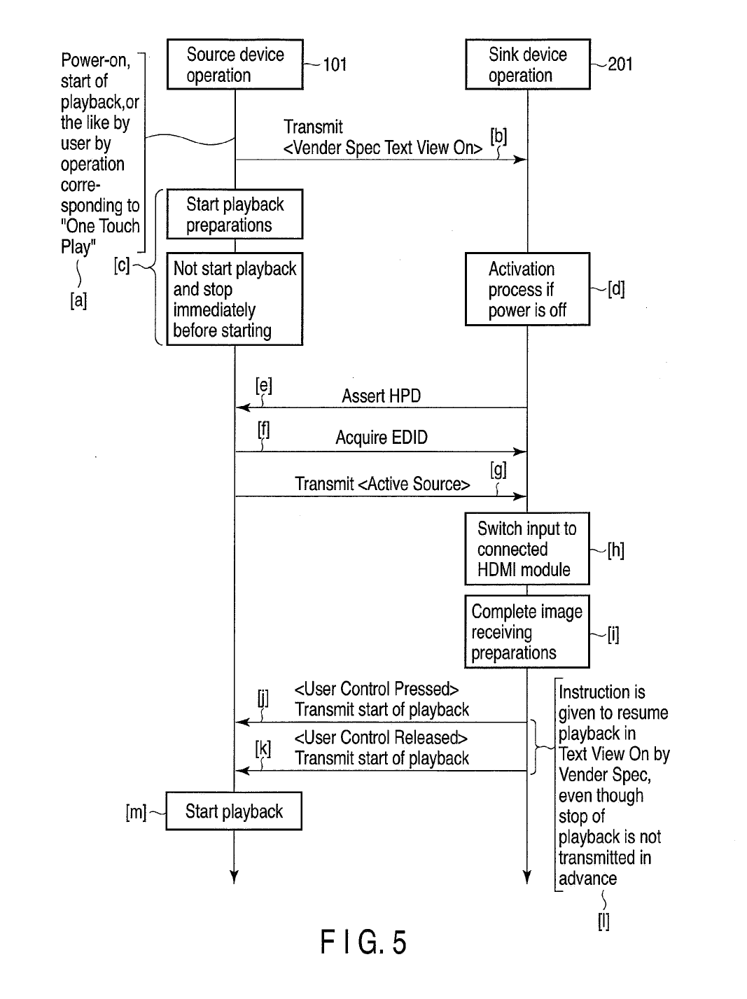

FIG. 5 illustrates another example of the embodiment.

When the user has made an operation corresponding to the “One Touch Play” [a], the source device 101 transmits a <Vender Spec Text View On> command to the sink device 201 [b]. The <Vender Spec Text View On> command is a command indicating that the pause state is maintained at the point in time when playback preparations have been completed (or immediately before playback preparations are completed) during the period of time until the source device 101 receives a <User Control Press (press of the button)> command [j] and a <User Control Release (release of the button)> command [k], which will be described later, using the “Remote Control Pass Through”, from the sink device 201 after starting preparations for playback of the content. That is, the source device 101 waits in a pause state at the point in time when the playback preparations are completed [c], during the period of time until the <User Control Release (release of button)> is received from the sink device 201 [k] after the source device 101 has transmitted a <Vender Spec Text View On> command to the sink device 201.

Although a detailed description will be omitted, when the power is off (non-on state), the sink device 201 is powered on and activated taking advantage that the secondary battery (direct current [DC] 31 V, 24 V, or 5 V) to the control CPU module, for example, excluding elements that require relatively large power consumption [d] is usually secured.

At the point in time when the activation process [d] has ended, the sink device 201 transmits HPD assertion to the source device 101 [e].

After receiving the HPD assertion [e], the source device 101 acquires EDID, transmits display> [f], and requests the sink device 201 to switch display of the video display device to the input terminal to which the source device is connected by the following <Active Source> command [g].

The sink device 201 switches the input to the source device 101 (HDMI module 111) according to the <Active Source> command from the source device 101 [h].

After that, the sink device 201 notifies the source device 101 of press of the button indicating start of playback [j] and release of the button [k], that is, “release of the pseudo-operation of the remote controller terminal” [1].

Upon receipt of the notification of “release of the pseudo-operation of the remote controller” from the sink device 201, the source device 101 starts playback of the content maintained in the pause state [m].

Thus (as shown in FIG. 5), since the activation process of the sink device is assigned higher priority when the sink device is powered off by defining the (Text View On) command as <Vender Spec Text View On> command using the <Vender Specification> command, the “HEAD MISSING” will be prevented more accurately.

When the <Vender Specification> is used, the cases where the source device 101 is making playback preparations and cannot respond to the pause (request) by the “Remote Control Pass Through, or where the pause cannot be performed since the user operation is prohibited such as the credit screen immediately after the content is started can also be coped with.

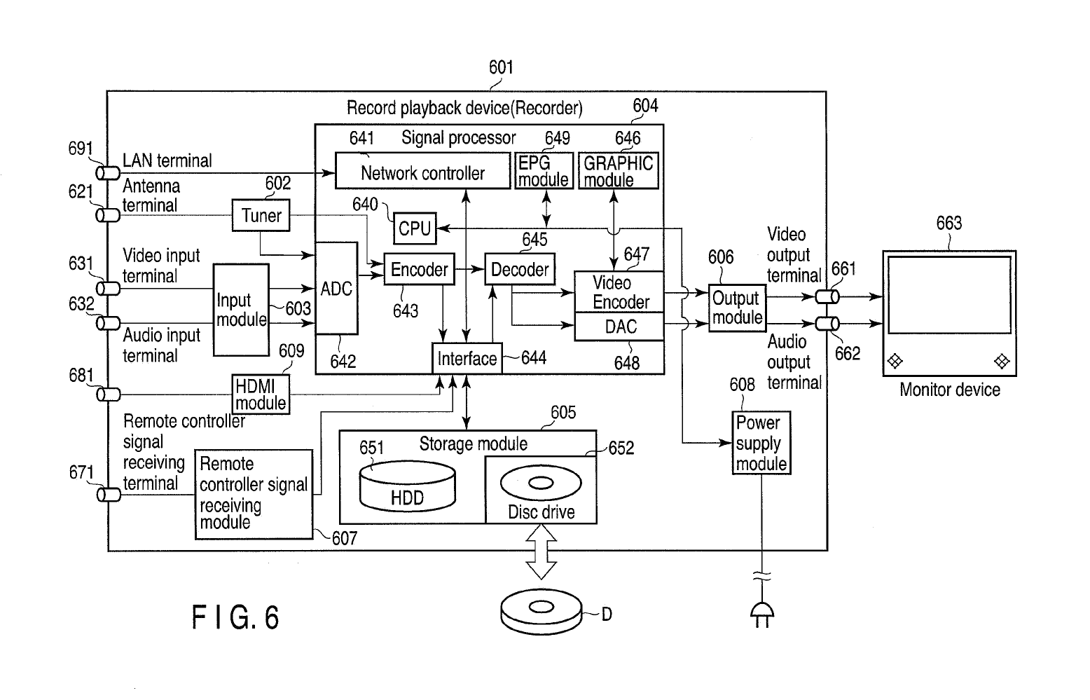

FIG. 6 shows an example of a recorder that can be used as a record playback device (source device) shown in FIG. 1.

A recorder 601 includes at least a tuner 602, an input module 603, a digital signal processor (DSP) 604, a storage module 605, an output module 606, a user operation input module (remote controller signal receiving module) 607, a power supply module 608, and an HDMI module 609 (corresponding to 111 shown in FIG. 1).

The tuner 602 selects a channel in which the program to be recorded is broadcast via an antenna connected to the antenna terminal 621, an optical cable, or the like.

The input module 603 accepts a video signal and an audio signal input via the video signal input terminal 631 and the audio signal input terminal 632.

The DSP 604 includes elements such as the control processing unit (CPU) 640, a network controller 641, an analog-to-digital converter (ADC) 642, an encoder 643, an interface 644, a decoder 645, a user interface graphics processing module (GUI processor) 646, a video encoder (video output processor) 647, a digital-to-analog converter (audio decoder [DAC]) 648, an electronic program guide (EPG) processing module 649, and the like. The HDMI module 609 is connected to the interface 644, but may also be connected to the network controller 641.

The control processing unit 640 controls the operations of the above-described elements and on/off of the main power supply (excluding the secondary circuit for inner control) of the power supply module 608.

The network controller 641 receives a program in a stream format supplied from an external network via a local area network (LAN) terminal 691. The LAN terminal 691 is connected to a relatively small network (home LAN) established in the same building, for example, or a home server (mass-storage device) and a connection network, and may be connected to an external network via a home server, for example. Further, a home LAN or a network should preferably be compatible with the Digital Living Network Alliance (registered trademark) (DLNA) standard.

The analog-to-digital converter (ADC) 642 converts input analog video and audio signals into digital signals, and inputs the converted signals to the encoder 643. When the tuner 602 receives digital broadcasts, the output from the tuner 602 is directly input to the encoder 643.

The encoder 643 encodes the input analog signal (video/audio) into a digital signal. Compression is compliant with a standard such as Moving Picture Experts Group-2 (MPEG-2), MPEG-4 (H.264-AVC), or the like.

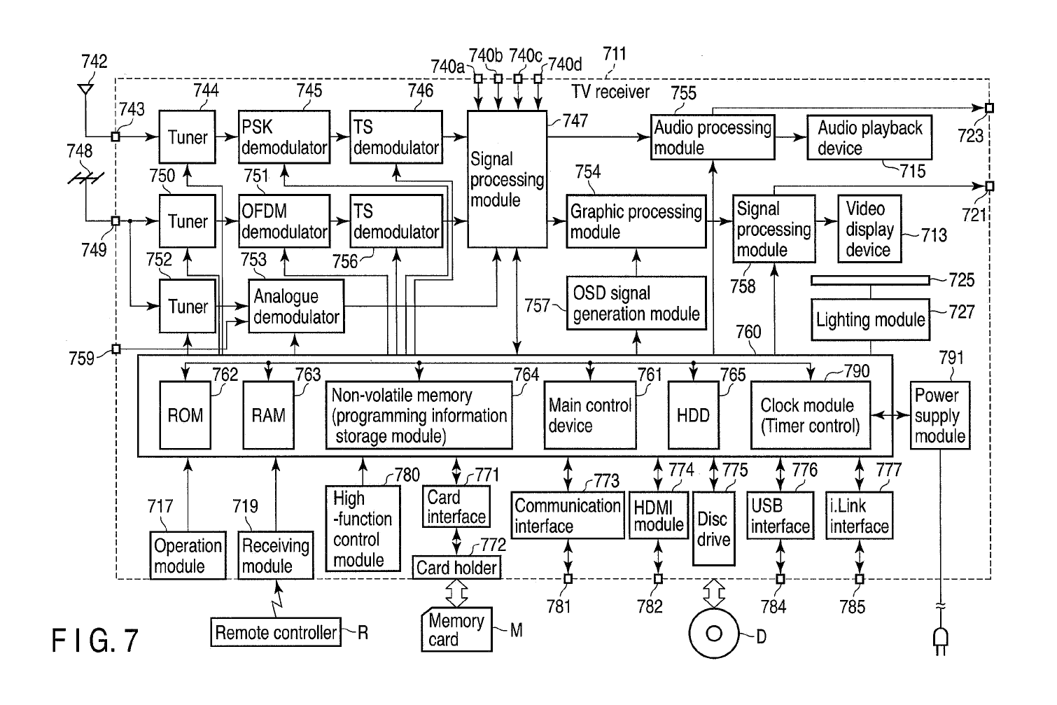

The interface 644 is used for data transfer to and from the record device 5, and for input of a control signal from the remote controller signal receiving module 607. A television receiving device (video playback device) 701 shown in FIG. 7 or an AV amplifier, not shown, or a hub is connected to the HDMI module 609 via the HDMI terminal 681. Although not shown, a DVD recorder, a DVD player, or the like, for example, is connected to the AV amplifier. Further, external devices such as an AV amplifier including an HDMI terminal, a PC, a DVD recorder integrated in an HDD, and a DVD player can be connected to the hub. When the HDMI terminal 681 is connected to the hub, it is also possible to provide connection with a network such as the Internet, and to read, play back, and write (record) moving image files (video files) and audio files (audio data) between a PC positioned on the network and a portable telephone or a portable terminal device, not shown.

The decoder 645 decodes the program compressed into MPEG-2 or MPEG-4 (H.264-AVC) format or the like.

The user interface graphics processing module 646 outputs a graphics user interface (GUI) screen display to be displayed on the monitor device 663 connected to the video output terminal 661 and the audio output terminal 662 via the output module 606.

The video encoder (video output processor) 647 synthesizes the video signal and the GUI screen display output from the GUI processing module 646 as necessary, and generates an output video signal to the output module 606 such that the monitor device 663 connected to the video output terminal 661 can display it.

The digital-to-analog converter (audio decoder [DAC]) 648 outputs an audio signal to the output module 606 such that an external speaker, for example, connected to the audio output terminal 662 can play it back.

The EPG processing module 649 acquires EPG data transmitted together with the program in digital DBS or terrestrial digital broadcasting, for example, or EPG data that can be externally acquired via the LAN terminal 691, and holds the acquired data as data on date, time, channel, and program length for displaying the program list in programming a program. The acquired EPG data is stored in a predetermined area in a memory device, not shown, or an HDD 651.

The storage module 605 includes a HD (Hard disk) within the HDD 651 or on a DVD-standard optical disc D loaded in a disc drive device 652, for example, and records a program in the HD in the HDD 651 or the optical disc D in the disc drive device 652, or plays back an already recorded program. By recording a program in a semiconductor memory (memory card) in addition to the disc drive device 652, a reader/writer (not shown) may also be prepared for playing back an already recorded program.

The output module 606 outputs the video signal from the video encoder 647 and the audio signal from the DAC 648 to a playback device connected to the video output terminal 661 and the audio output terminal 662, such as the monitor device and the speaker device.

The remote controller signal receiving module 607 inputs a user operation input received by the remote controller signal receiving terminal 671 to the main control module (CPU) 640 via the interface 644.

The main power supply of the power supply module 608 can be turned off by the control of the main control module 640. The power supply module 608 turns on the main power supply at the point in time when the reservation time set in the timer portion, not shown, has come, and maintains the operation of each of the above-described elements to an operable state.

FIG. 7 shows an example of a configuration of a television receiving device that can be used as a video display device (sink device) shown in FIG. 1.

The television receiving device 711 includes a video display device 713 configured to display a video corresponding to the video signal (video data), an audio playback device 715 configured to play back an audio output (audio data) as represented by a speaker, for example, an operation module 717 configured to receive a control instruction (control input) signal from the user, a remote controller reception module 719 configured to receive an operation information (control input) signal via a remote control device R from the user, a control block (control module) 760, and the like. The video display device (display device) 713 is a liquid crystal panel device, for example, and displays a video by selectively letting illumination light (backlight) from the appended illumination device 725 pass through lit by a lighting module 727. Further, the illumination device 725 is lit at a predetermined drive voltage with the lighting module 727 defined based on the brightness of the surrounding and the difference between the consecutive lit time and non-lit time, that is, the temperature of the illumination device 725.

The control module 760 includes a main control device (large-scale IC [LSI] for the main control) 761 referred to as the CPU or the micro processing unit (MPU).

The control module 760 (main control device 761) controls each portion (element) that will be described below according to the information and data externally supplied via the network connection module (communication interface) 773.

The control module 760 also includes a read-only memory (ROM) 762 containing a control program executed by the main control device 761, a random access memory 763 (RAM) configured to provide a work area for the main control device 761, a non-volatile memory (NVM) 764, and an HDD 765.

The NVM 764 also holds messages, decoded schedule information, and the like that are retrieved via the communication interface 773 via the control module 760.

An interface group of an arbitrary number, such as a card interface 771 capable of reading information from the card-shaped medium (memory card) M, which is a semiconductor memory, and writing information to the memory card M, a network communication module (communication interface) 773, an HDMI module 774 (corresponding to 211 of FIG. 1), a disc drive device 775 used to read information from the optical disc D, that is, moving image data and audio data, and to write information to the optical disc, a USB interface, and i.Link interface 777 are connected to the control module 760. The control module 760 functions, for example, as external devices, a hub (extension device), or a network control device that agrees with each of the interfaces.

The card interface 771 is capable of reading video and audio files from the memory card M inserted into the card holder 772, and capable of writing video and audio files to the memory card M.

The communication interface 773 is connected to a LAN terminal (port) 781, and receives control information and moving image data supplied via an external device such as a portable terminal device or a mobile PC, not shown, from the remote controller device, according to the Ethernet (registered trademark) standard. By connecting a LAN-compliant hub, the communication interface 773 is capable of connecting devices such as a LAN-compliant HDD (network attached storage [NAS] HDD), a PC, and a DVD recorder integrated in an HDD.

A recorder (video playback device) 201 shown in FIG. 6 as an example or an AV amplifier, not shown, or a hub is connected to the HDMI module 774 via the HDMI terminal 782. Although not shown, a DVD recorder or a DVD player, for example, is connected to the AV amplifier. Further, an external device, such as a DVD recorder or a DVD player, not shown, is connected to the AV amplifier. When the HDMI terminal 782 is connected to a hub, it is also possible to establish connection with a network such as the Internet via a broadband router, for example, or to play back and write (record) moving image files (video data) and audio files (audio data) to and from a mobile telephone, a mobile terminal device, or a mobile terminal.

The disc drive device 775 reads or records the information, for example, moving image data and audio data from the DVD-format optical disc D. When the set optical disc is in a CD format, the audio data is read and played back, and the title of the song and the playing time, for example, are output to the video display device 713 such that the video display device 713 can display them.

The USB interface 776 is capable of connecting an HDD, a keyboard, and the like that are formed so as to be accessible via a USB interface, via a hub, not shown, connected to the USB port 784, and is capable of transferring information to and from each of the USB devices. Needless to say, a card reader/writer of a mobile telephone, a digital camera, and a memory card corresponding to the USB interface 776 can also be connected thereto.

Although not shown, external devices such as an audio-visual (AV)-HDD or a digital (D)-Video Home System (VHS), or an external tuner or a Set Top Box (STB) (cable television receiver) can be serially connected to the i.Link interface 777, and information can be transferred between the i.Link interface 777 and an arbitrary connected device.

Although not shown, in addition to each of the interfaces, or in place of an arbitrary one of a plurality of interfaces, a network controller compliant with the DLNA standard, for example, or the Bluetooth (registered trademark), not shown, may be prepared, and a recorder device, an HDD device, or a portable terminal device capable of transferring data may also be connected, as a matter of course.

The control module 760 includes a timer controller (clock module) 790. The clock module 90 manages information such as time, reservation time (date and time) for record programming and the channel to be recorded, and holds the information. The clock module 790 constantly acquires “hour and minute information” which is referred to as Time Offset Table (TOT) in received digital broadcasting via the terrestrial digital tuner 750. That is, the hour and minute management can be performed at the level equal to that of the device integrating a radio clock. Needless to say, time signals can be acquired at a predetermined time every day from an analog predetermined channel received via the terrestrial analog tuner 752. Further, the clock module 790 also functions as a timing module with respect to information for a scheduler function or a messenger function supplied from the portable terminal device. Needless to say, the clock module 790 is capable of controlling on/off (energizing) of the power supply for commercial purposes by the power supply module 791. That is, in cases other than a case where energizing is physically impossible since the plug is pulled off, the secondary battery device (direct-current (DC) 31V, 24V, or 5V) to the control module 760, for example, excluding elements that require relatively large power consumption, such as the video display device 713, the signal processing module 747, and the HDD is usually secured, and the video display device 713, the signal processing module 747, the HDD 765 or the like is activated at a predefined time, as a matter of course.

A satellite digital television broadcast signal received through a BS/CS (satellite wave) digital broadcast receiving antenna 742 is supplied to the satellite digital broadcast tuner 744 through an input terminal 743.

The tuner 744 selects a broadcast signal of a desired channel based on a control signal from the control module 760, and outputs this selected broadcast signal to a phase shift keying (PSK) demodulator 745.

The PSK demodulator 745 demodulates the broadcast signal selected by the tuner 744 based on the control signal from the control module 760 to obtain a transport stream (TS) including a desired program, and outputs the demodulated broadcast signal to a TS demodulator 746.

The TS demodulator 746 performs TS decoding processing with respect to a signal subjected to transport stream multiplexing based on a control signal from the control module 760, and outputs a digital video signal and a digital audio signal of a desired program to the signal processing module 747. Further, the TS demodulator 746 outputs various kinds of data (service information) required to acquire a program (content) supplied based on digital broadcasting, electronic program guide (EPG) information, program attribute information (a program category or the like), subtitle information, and other information to the control module 760.

Moreover, a digital terrestrial broadcast signal received by a terrestrial broadcast receiving antenna 748 is supplied to the digital terrestrial broadcast tuner 750 through an input terminal 749.

The tuner 750 selects a broadcast signal of a desired channel based on the control signal from the control module 760, and outputs the selected broadcast signal to an orthogonal frequency division multiplexing (OFDM) demodulator 751.

The OFDM demodulator 751 demodulates the broadcast signal selected by the tuner 750 based on the control signal from the control module 760 to obtain a transport stream including the desired program, and outputs this stream to a TS demodulator 756.

The TS demodulator 756 performs TS decoding processing with respect to a signal subjected to transport stream (TS) multiplexing under control of the control module 760, and outputs a digital video signal and a digital audio signal of a desired program to the signal processing module 747. It is to be noted that the signal processing module 747 acquires various kinds of data required to acquire a program superimposed on a digital broadcast wave and supplied in this state, electronic program guide (EPG) information, program attribute information (a program category or the like), and other information, and outputs such information to the control module 760.

An analog terrestrial television broadcast signal received by the terrestrial broadcast receiving antenna 748 is supplied to the analog terrestrial broadcast tuner 752 through the input terminal 749, thereby selecting a broadcast signal of a desired channel. The broadcast signal selected by the tuner 752 is demodulated into analog content, i.e., an analog video signal and an analog audio signal by an analog demodulator 753, and then output to the signal processing module 747.

The signal processing module 747 selectively performs predetermined digital signal processing with respect to a digital video signal and a digital audio signal respectively supplied from the PSK demodulator 745 and the OFDM demodulator 751, and outputs the processed signals to the graphic processing module 754 and the audio processing module 755.

To the signal processing module 747 are also connected a plurality of (four in the illustrated example) input terminals 740a, 740b, 740c, and 740d. These input terminals 740a to 740d enable inputting analog video signals and analog audio signals from the outside of the television receiver 711.

The signal processing module 747 selectively digitizes the analog video signals and the analog audio signals respectively supplied from the analog demodulator 753 and the input terminals 740a to 740d, carries out predetermined digital signal processing with respect to the digitized video signals and audio signals, and then outputs the processed signals to the graphic processing module 754 and the audio processing module 755.

The graphic processing module 754 has a function of superimposing an OSD signal generated by an on-screen display (OSD) signal generation module 757 on a digital video signal supplied from the signal processing module 747 and outputting an obtained signal. The graphic processing module 754 can selectively output an output video signal from the signal processing module 747 and an output OSD signal from the OSD signal generation module 757, and can combine both the outputs so that each of the outputs constitutes a half of a screen and can output this combined output.

It is to be noted that the output OSD signal output from the OSD signal generation module 757 can be superimposed on the displayed moving picture in a “semitransparent” state (forming a part of a regular video signal to be permeable) and output in this state when a parameter for α blending is set.

The graphic processing module 754 also performs processing of superimposing subtitle information on a video signal based on a control signal from the control module 760 and the subtitle information when a broadcast signal has a subtitle signal attached thereto and a subtitle can be displayed. It is to be noted that the graphic processing module 754 supplies a moving picture message decoded in the high-function control module 780 or an image showing a scheduler function screen to the image signal processing module 758 through the control module 760.

A digital video signal output from the graphic processing module 754 is supplied to the image signal processing module 758. The image signal processing module 758 converts the digital image signal fed from the graphic processing module 754 into an analog image signal in such a manner that this signal can be reproduced as an image (moving picture/still image) output by the display device 713, i.e., the monitor. Incidentally, it is needless to say that an extended projection device (a projector device) or an external monitor device may be connected as an external device with an output terminal 721 connected with the image signal processing module 758. Further, a DVD recorder device using, e.g., an optical disk conforming to a DVD standard as a recording medium or a video recorder device using a conventional video tape as a recording medium may be connected with the output terminal 721.

The audio processing module 755 is connected to an audio playback device 715, i.e., a speaker or the like, and converts a digital audio signal supplied from the signal processing module 747 into an analog audio signal. It is to be noted that, although not explained in detail, a audio signal (an audio output) may be of course output to an external speaker connected with an output terminal 723, an audio amplifier (a mixer amplifier), or a headphone output terminal prepared as one conformation of the output terminal 723 in such a manner that this audio signal can be reproduced as an audio output.

In the control module 760, information for the scheduler function or the messenger function input to the high-function control module 780 through the communication I/F module 773 is checked for, e.g., double booking with respect to an already set recording reservation, clock time information provided by the clock module 790 and the NVM 764, a date and hour and a channel for a time order (a date order) in the scheduler function, and other factors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display device comprising:
a signal playback module configured to receive content;
a signal control module configured to instruct a source device to stop and start playback of the content; and
a bidirectional communication interface configured to transfer a control signal between the signal control module and the signal playback module.

2. The apparatus of claim 1, wherein the signal control module supplies a signal instructing stop of content playback to the source device until a signal instructing start of playback of the content is given from the signal control module.

3. The apparatus of claim 2, wherein the signal control module notifies the source device of signal output and indicates stop of playback of the content from the signal control module by at least one of a character string or blinking light.

4. A recording and playback apparatus comprising:
a signal playback module configured to transmit content to a sink device;
a signal control module configured to stop or start playback of the content based on an instruction from the the sink device to stop or start playback of the content, respectively; and
a bidirectional communication interface configured to transfer a control signal between the signal control module and the signal playback module.

5. The apparatus of claim 4, wherein the sink device instructs the signal control module to stop or start playback of the content until the sink device gives a start instruction to start playback of the content.

6. The apparatus of claim 5, wherein the signal control module indicates that content playback has stopped by at least one of a character string or a blinking light until the sink device instructs that playback of the content start.

7. A playback signal control method comprising:
transmitting a request to stop playback of content to a source device; and
transmitting a request to release the request to stop playback of the content and to start playback of the content to the source device when the content can be played back.

8. The method of claim 7, wherein the request to release the request to stop playback of the content and to start playback of the content to the source device comprises a control command giving a notification to wait until a request to start playback of the content is given.
